(19) United States
(12) Patent Application Publication
(10) Pub. No.: US 2024/0393134 A1
(43) Pub. Date: Nov. 28, 2024

(54) LANE-LEVEL DIFFICULTY AND CUSTOMED NAVIGATION

(71) Applicant: FORD GLOBAL TECHNOLOGIES, LLC, Dearborn, MI (US)

(72) Inventor: Oliver Lei, Windsor (CA)

(21) Appl. No.: 18/323,053

(22) Filed: May 24, 2023

(51) Int. Cl. G01C 21/00; G01C 21/34

(52) U.S. Cl. CPC G01C 21/3874; G01C 21/3461; G01C 21/3484; G01C 21/3889

(57) ABSTRACT

Customized routing of vehicles is performed based on lane-level difficulty includes extracting data elements from traffic information indicative of performance of maneuvers by the vehicles. Raw difficulty scores are determined for each of the maneuvers based on the data elements. Lanes of travel are identified for the maneuvers. For each lane, a lane-level difficulty score is generated based on the raw difficulty scores corresponding to the maneuvers using that lane. Vehicles are routed accounting for the lane-level difficulty scores to include only maneuvers that have lane-level difficulty scores at or below a difficulty preference.

### TECHNICAL FIELD

Aspects of the present disclosure generally relate to the automatic determination of lane-level difficulty for maneuvers, as well as the customized routing of vehicles based on the lane-level difficulty.

### BACKGROUND

Cellular vehicle-to-everything (C-V2X) allows vehicles to exchange information with other vehicles, as well as with infrastructure, pedestrians, networks, and other devices. Vehicle-to-infrastructure (V2I) communication enables applications to facilitate and speed up communication or transactions between vehicles and infrastructure. In a vehicle telematics system, a telematics control unit (TCU) may be used for various remote-control services, such as over the air (OTA) software download, eCall, and turn-by-turn navigation.

### SUMMARY

In one or more illustrative examples, a system for customized routing of vehicles based on lane-level difficulty includes a data store configured to maintain lane-level difficulty scores for a plurality of lanes of travel of roadway, the lane-level difficulty scores being computed based on traffic information compiled from a plurality of vehicles having traversed the roadway and one or more processors. The one or more processors are configured to receive a query for a route from a vehicle, identify a difficulty preference for the vehicle based on the query, compute the route to include only maneuvers that have lane-level difficulty scores at or below the difficulty preference, and send the route to the vehicle, responsive to the query.

In one or more illustrative examples, a method for customized routing of vehicles based on lane-level difficulty includes extracting data elements from traffic information indicative of performance of maneuvers by the vehicles; determining raw difficulty scores for each of the maneuvers based on the data elements; identifying lanes of travel for the maneuvers; for each lane, generating a lane-level difficulty score based on the raw difficulty scores corresponding to the maneuvers using that lane; and routing vehicles accounting for the lane-level difficulty scores to include only maneuvers that have lane-level difficulty scores at or below a difficulty preference.

In one or more illustrative examples, non-transitory computer-readable medium comprising instructions for customized routing of vehicles based on lane-level difficulty that, when executed by one or more processors, cause the one or more processors to perform operations including to extract data elements from traffic information indicative of performance of maneuvers by the vehicles; determine raw difficulty scores for each of the maneuvers based on the data elements; identify lanes of travel for the maneuvers; for each lane, generate a lane-level difficulty score based on the raw difficulty scores corresponding to the maneuvers using that lane; receive a query for a route from a vehicle; identify a difficulty preference for the vehicle based on the query; compute the route to include only maneuvers that have lane-level difficulty scores at or below the difficulty preference; and send the route to the vehicle, responsive to the query.

### BRIEF DESCRIPTION OF THE DRAWINGS

FIG. 1A illustrates an example system for cloud-based navigation accounting for maneuver difficulty;

FIG. 1B illustrates an alternate example system using local and edge-based computation accounting for maneuver difficulty;

FIG. 2 illustrates an example of details of a difficulty score computation of the lane-level difficulty;

FIG. 3A illustrates an example scenario of an ego vehicle being routed to turn left onto a roadway as a portion of a route;

FIG. 3B illustrates an alternate example scenario of the ego vehicle being routed to turn left onto the roadway as a portion of the route;

FIG. 4 illustrates an example process for determining lane-level difficulties along the roadway;

FIG. 5 illustrates an example process for customized routing of vehicles based on the lane-level difficulty; and

FIG. 6 illustrates an example of a computing device for use in interoperability of vehicles having different communications technologies.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

Navigation systems may be used to direct a vehicle along a route from an origin (or current) location to a destination location. These systems may generate a route for the vehicle, while minimizing the distance to travel and/or the time required to travel. In some cases, the route may also be adjusted according to traffic information, such that slowdowns are accounted for when minimizing for time.

Crowd-sourced traffic information may include the speed and quantity of vehicles traversing road segments along the route. The speed may be defined as an average of all vehicle speeds in all lanes along that road segment. Yet, there may be multiple types of lanes at the same intersection, e.g., left turn, straight, and right turn. Thus, the average speed of the road segment may not represent the vehicle speed for each lane type. For example, some intersections may require a long time to complete a left turn onto a non-stop two-way traffic road from a stop sign. This case may not be reflected in the traffic information, which may instead show a shorter time for travel as averaged across all lanes. Based on the traffic information, the user may assume the left turn on that intersection is not slow. As a result, a route calculated by the navigation system may include an unduly slow left turn onto a nonstop two-way traffic road.

In addition, some driving maneuvers, such as left turns, can be difficult to complete as it may require the driver to make a fast turn to fit through the two-way traffic. This maneuver may exceed the comfort or capabilities of some drivers. When the user realizes this situation, the vehicle may already be in the left turn lane. The driver may then have to wait or change lanes to exit from the situation. Sometimes, changing lanes may not be feasible if the driver is the first vehicle in the left lane and there are many vehicles in the adjacent lanes. This can be very frustrating and sometimes the driver may simply take the uncomfortable turn.

An enhanced approach to route generation may compute the route based on maneuver difficulty and user preference. Lane-level difficulty scores indicative of how difficult it is to traverse that lane may be determined from the traffic information. For instance, faster speed, more changes in speed, and longer wait time may indicate a more difficult traversal, while slower speed, fewer changes in speed, and shorter wait time may indicate an easier traversal. The lane of travel may be based on a direction of a turn performed by the vehicle performing the maneuver (e.g., if the vehicle turned left, then the vehicle may be assumed to have used the left turn lane). The lane-level difficulty scores may be compared to a difficulty preference for the vehicle to ensure that the route only includes maneuvers that have lane-level difficulty scores at or below the difficulty preference. Further aspects of the disclosure are discussed in detail herein.

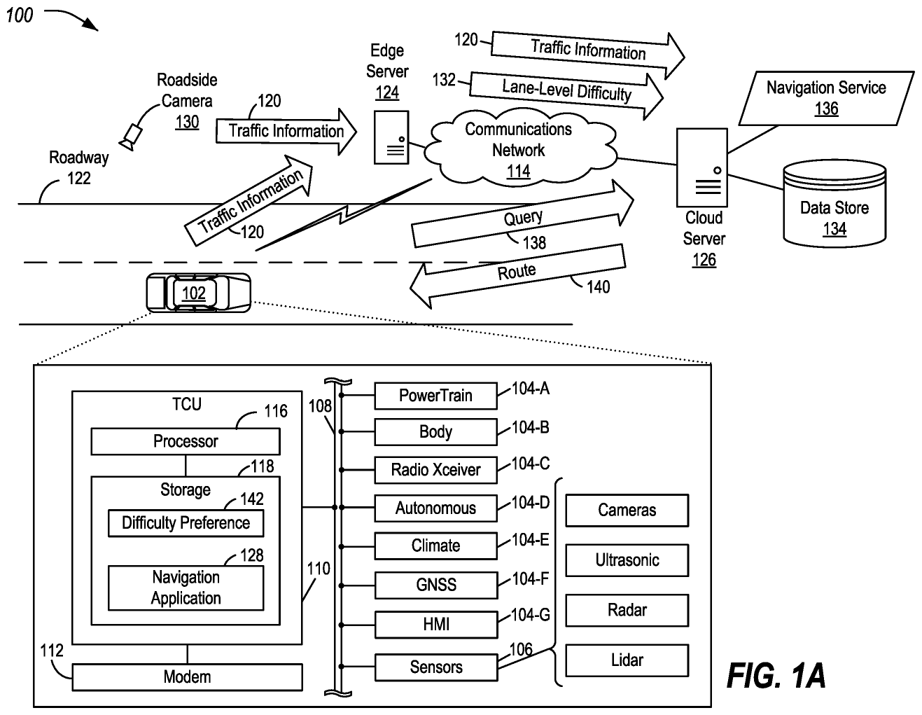

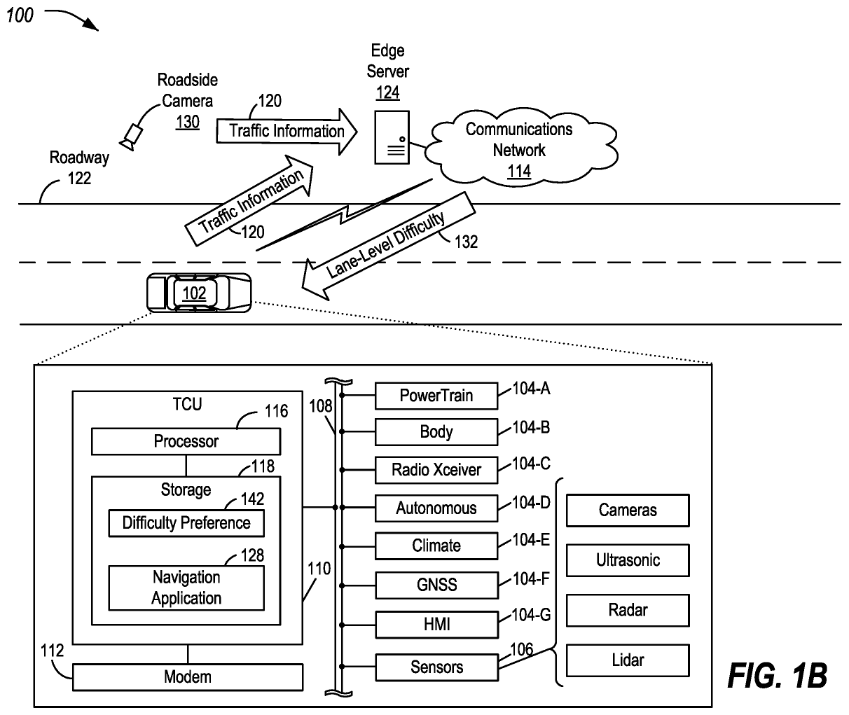

FIG. 1A illustrates an example system 100A for cloud-based navigation accounting for maneuver difficulty. The system 100A may include an edge server 124 configured to determine a lane-level difficulty 132 for a maneuver based on traffic information 120. The traffic information 120 may be descriptive of factors such as waiting time, two-way traffic volume, and speed data. In the system 100A, the lane-level difficulty 132 information may be used by a cloud server 126 to determine the route 140 based on a navigation query 138 from a vehicle 102. For example, the navigation query 138, the lane-level difficulty 132, and a difficulty preference 142 of the vehicle 102 may be collectively used by the cloud server 126 to make routing decisions. The difficulty preference 142 may specify a value within which any lane-level difficulties 132 of suggested maneuvers (e.g., a left turn) along the route 140 should stay within.

The vehicle 102 may include various types of automobile, crossover utility vehicle (CUV), sport utility vehicle (SUV), truck, recreational vehicle, boat, plane or other mobile machine for transporting people or goods. Such vehicles 102 may be human-driven or autonomous. In many cases, the vehicle 102 may be powered by an internal combustion engine. As another possibility, the vehicle 102 may be a battery electric vehicle (BEV) powered by one or more electric motors. As a further possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). Alternatively, the vehicle 102 may be an Automated Vehicle (AV). The level of automation may vary between variant levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs). It should be noted that while automotive vehicles 102 are being used as examples of traffic participants, other types of traffic participants may additionally or alternately be used, such as bicycles, scooters, and pedestrians.

The vehicle 102 may include a plurality of controllers 104 configured to perform and manage various vehicle 102 functions under the power of the vehicle battery and/or drivetrain. As depicted, the example vehicle controllers 104 are represented as discrete controllers 104 (i.e., 104A through 104G). However, the vehicle controllers 104 may share physical hardware, firmware, and/or software, such that the functionality from multiple controllers 104 may be integrated into a single controller 104, and that the functionality of various such controllers 104 may be distributed across a plurality of controllers 104.

As some non-limiting vehicle controller 104 examples: a powertrain controller 104A may be configured to provide control of engine operating components (e.g., idle control components, fuel delivery components, emissions control components, etc.) and for monitoring status of such engine operating components (e.g., status of engine codes); a body controller 104B may be configured to manage various power control functions such as exterior lighting, interior lighting, keyless entry, remote start, and point of access status verification (closure status of the hood, doors and/or trunk of the vehicle 102); a radio transceiver controller 104C may be configured to communicate with key fobs, mobile devices, or other local vehicle 102 devices; an autonomous controller 104D may be configured to provide commands to control the powertrain, steering, or other aspects of the vehicle 102; a climate control management controller 104E may be configured to provide control of heating and cooling system components (e.g., compressor clutch, blower fan, temperature sensors, etc.); a global navigation satellite system (GNSS) controller 104F may be configured to provide vehicle location information; and a human-machine interface (HMI) controller 104G may be configured to receive user input via various buttons or other controls, as well as provide vehicle status information to a driver, such as fuel level information, engine operating temperature information, and current location of the vehicle 102.

The controllers 104 of the vehicle 102 may make use of various sensors 106 in order to receive information with respect to the surroundings of the vehicle 102. In an example, these sensors 106 may include one or more of cameras (e.g., advanced driver-assistance system (ADAS) cameras), ultrasonic sensors, radar systems, and/or lidar systems.

One or more vehicle buses 108 may include various methods of communication available between the vehicle controllers 104, as well as between a TCU 110 and the vehicle controllers 104. As some non-limiting examples, the vehicle bus 108 may include one or more of a vehicle controller area network (CAN), an Ethernet network, and a media-oriented system transfer (MOST) network.

The TCU 110 may include network hardware configured to facilitate communication between the vehicle controllers 104 and with other devices of the system 100A. For example, the TCU 110 may include or otherwise access a modem 112 configured to facilitate communication over a communication network 114. The TCU 110 may, accordingly, be configured to communicate over various protocols, such as with the communication network 114 over a network protocol (such as Uu). The TCU 110 may, additionally, be configured to communicate over a broadcast peer-to-peer protocol (such as PC5), to facilitate C-V2X communications with devices such as other vehicles 102. It should be noted that these protocols are merely examples, and different peer-to-peer and/or cellular technologies may be used.

The TCU 110 may include various types of computing apparatus in support of performance of the functions of the TCU 110 described herein. In an example, the TCU 110 may include one or more processors 116 configured to execute computer instructions, and a storage 118 medium on which the computer-executable instructions and/or data may be maintained. A computer-readable storage medium (also referred to as a processor-readable medium or storage 118) includes any non-transitory (e.g., tangible) medium that participates in providing data (e.g., instructions) that may be read by a computer (e.g., by the processor(s)). In general, the processor 116 receives instructions and/or data, e.g., from the storage 118, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, etc.

The TCU 110 may be configured to include one or more interfaces from which vehicle 102 information may be sent and received. For example, the TCU 110 may be configured to facilitate the collection of traffic information 120 from the vehicle controllers 104 connected to the one or more vehicle buses 108. While only a single vehicle bus 108 is illustrated, it should be noted that in many examples, multiple vehicle buses 108 are included, usually with a subset of the controllers 104 connected to each vehicle bus 108.

The traffic information 120 may include signals retrieved from the controllers 104 and/or the sensors 106 over the vehicle buses 108. The traffic information 120 may include data descriptive of various vehicle signals along the vehicle bus 108. These signals may be useful in the identification of conditions along the roadway 122. For instance, the signals may indicate speed, direction, orientation, etc. of the vehicle 102.

The traffic information 120 may further include contextual information with respect to the location of the vehicle 102 when the events occurred. In an example, the TCU 110 may also capture location information from the GNSS controller 104F that may be used to augment the traffic information 120 with locations of where the vehicle 102 was when the traffic information 120 was captured occurred. In another example, the time at which the event occurred may be included as contextual information. The traffic information 120 captured by the TCU 110 may also include, as some non-limiting examples, latitude, longitude, time, heading angle, speed, throttle position, brake status, steering angle, headlight status, wiper status, external temperature, turn signal status, ambient light (daytime, evening, etc.) or other weather conditions, etc.

The TCU 110 may be further configured to transmit the traffic information 120 over the communication network 114 for reception by the edge server 124 and/or the cloud server 126. In an example, the management of sending the traffic information 120 may be handled by a navigation application 128 executed by the TCU 110.

In an example, the collection of traffic information 120 may be performed in an event-based manner, in which the vehicles 102 send the traffic information 120 to the cloud server 126 responsive to occurrence of the event. For instance, when an event is indicated by the vehicle 102 (such as completion of a turn or other traffic maneuver), the traffic information 120 may be sent from the modem 112 of the vehicle 102 to the edge server 124 and/or the cloud server 126. Examples of such traffic maneuvers may include proceeding through an intersection, merging onto an expressway, taking an exit off an expressway, switching lanes along the same roadway 122, etc.

Alternatively, the traffic information 120 may be compiled from continuously sampled data from the vehicle buses 108, e.g., to the storage 118 of the TCU 110, which may allow for batch uploading of traffic information 120 from the vehicle 102.

Roadside cameras 130 may also be used to capture traffic information 120, which may also be sent to the cloud server 126. For instance, the roadside cameras 130 may capture information such as the speeds of passing vehicles 102, counts of vehicles 102 waiting at a traffic light, counts of vehicles 102 turning left, counts of vehicles 102 turning right, counts of vehicles 102 continuing straight ahead, waiting time of vehicles 102 to complete the turns, etc.

The edge server 124 may be configured to receive the traffic information 120. In an example, the edge server 124 may utilize a road side unit (RSU) to capture transmissions from the vehicles 102, and may extract the traffic information 120 from those transmissions. In another example, the roadside camera 130 may communicate with the RSU to provide the captured image data to the RSU for forwarding to the edge server 124.

The edge server 124 may process the traffic information 120 to determine the lane-level difficulty 132. The lane-level difficulty 132 may be a determined quantity along a scale that is indicative of the relative difficulty of the vehicle 102 traversing the lane to complete the maneuver. It should be noted that this measure may differ by lane of the roadway 122.

The edge server 124 may be further configured to forward the traffic information 120 and the lane-level difficulty 132 to the cloud server 126. The cloud server 126 may receive the traffic information 120 and the lane-level difficulty 132 and may store the traffic information 120 and the lane-level difficulty 132 in a data store 134. This information may be compiled into aggregate traffic conditions and lane-level difficulty 132 per road segment and lane by a navigation service 136 executed by the cloud server 126.

Using the services of the navigation service 136 of the cloud server 126, vehicles 102 may be configured to perform navigation queries 138. For example, the vehicle 102 may send a navigation query 138 including a current location of the vehicle 102 and a desired destination location for the vehicle 102. The navigation service 136 may receive the query 138, construct a route 140 in accordance with the query 138, and send the route 140 back to the vehicle 102 in response to the query 138. The query 138 may, in some cases also include difficulty preferences 142 of the user of the vehicle 102. These difficulty preferences 142 may include, for example, a score threshold that any suggested maneuvers (e.g., a left turn) along the route 140 should stay within to be allowed to be included in the route 140.

FIG. 1B illustrates an alternate example system 100B using local and edge-based computation accounting for maneuver difficulty. As compared to the system 100A, the system 100B instead receives the lane-level difficulty 132 from the edge server 124 and computes the route 140 local to the vehicle 102.

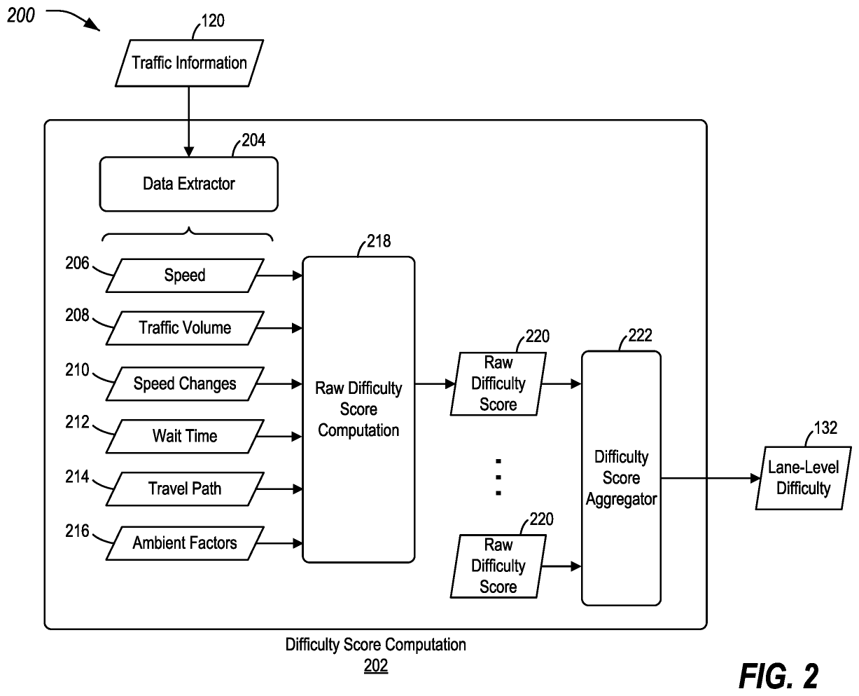

FIG. 2 illustrates an example 200 of details of a difficulty score computation 202 of the lane-level difficulty 132. In an example, the difficulty score computation 202 of the lane-level difficulty 132 may be implemented by the edge server 124 receiving the traffic information 120 from vehicles 102 local to the edge server 124. The traffic information 120 may be received from vehicles 102 in proximity to the edge server 124. This traffic information 120 may be received by the difficulty score computation 202 and sent to a data extractor 204 for analysis.

The data extractor 204 may extract various data elements from the traffic information 120 indicative of the vehicle 102 performance of a maneuver. These data elements may include, as some examples, one or more of: speed data 206, traffic volume data 208, speed change data 210, wait time data 212, travel path data 214, and ambient factor data 216.

The speed data 206 may be indicative of how fast the vehicle 102 sending the traffic information 120 is moving. The speed data 206 may be a factor in the determination of the lane-level difficulty 132, as higher speeds may increase the difficulty of the maneuver, especially if the vehicle 102 to make multiple turns or move around obstacles. Likewise, slower speeds may indicate a lower level of difficulty. The speed data 206 may be quantified into a value indicative of the difficulty. In an example, the speed of other vehicles 102 surrounding the vehicle 102 may be averaged, and then projected into a value along a range such as 1 to 100, with 1 indicating slow speeds and 100 indicating the fastest speeds.

The traffic volume data 208 may be indicative of the quantity of vehicles 102 sending the traffic information 120. The traffic volume data 208 may be a factor in the determination of the lane-level difficulty 132, as higher volumes may increase the difficulty of the maneuver. Likewise, lesser volumes may indicate a lower level of difficulty. The traffic volume data 208 may be quantified into a value indicative of the difficulty. In an example, the quantity of other vehicles 102 surrounding the vehicle 102 may be counted during the time of the maneuver, and then projected into a value along a range such as 1 to 100, with 1 indicating no other traffic and 100 indicating a maximum amount of traffic (e.g., gridlock).

The speed change data 210 may be indicative of changes in speed of the vehicle 102 over time. For example, if vehicles 102 speed up or slow down quickly, then those actions may indicate an increased difficulty of the maneuver. Likewise, fewer speed changes may indicate a lower level of difficulty. In an example, the quantity of speed changes of the vehicle 102 may be counted, and then projected into a value along a range such as 1 to 100, with 1 indicating no speed changes and 100 indicating a large quantity of speed changes.

The wait time data 212 may be indicative of an amount of time that the vehicle 102 spent waiting to perform the maneuver. For example, if the vehicle 102 waits longer to complete a left turn (as an example), then that increased time spent waiting may indicate an increased difficulty of the maneuver (e.g., because the vehicle 102 needs to monitor conditions to ensure that the maneuver may be completed). A shorter amount of wait may likewise indicate a lower level of difficulty. In an example, the wait time of the vehicle 102 may be identified (e.g., in seconds), and then projected into a value along a range such as 1 to 100, with 1 indicating a value of the shortest possible time (e.g., one second) and 100 indicating a large quantity of time (e.g., at least a maximum time such as 5 minutes).

The travel path data 214 may indicate the overall path that the vehicle 102 took when performing the maneuver. For example, the travel path data 214 may indicate which leg of an intersection the vehicle 102 entered and which leg of the intersection the vehicle 102 exited. This information may be indirectly indicative of the lane of travel of the vehicle 102. For example, if the vehicle 102 turns left, then the vehicle 102 may be inferred to have traversed through a left turn lane. Or, if the vehicle 102 goes straight through, then the vehicle 102 may be presumed to have been in a straightaway lane. By using the travel path data 214, it may be unnecessary for the difficulty score computation 202 to require detailed lane-level maps and lane-level tracking of the vehicle 102. The travel path data 214 may be quantified as an angular change in heading. For example, rotating of the vehicle 102 heading during the maneuver between a minimum number of degrees to a maximum number of degrees (e.g., 75-115 degrees to the left) may be counted as a left lane, rotating of the vehicle 102 heading during the maneuver between a minimum number of degrees to a maximum number of degrees (e.g., 75-115 degrees to the right) may be counted as a right lane, and continuing between the left and right lane thresholds may be counted as a straightaway lane.

The ambient factor data 216 may indicate conditions related to the surroundings of the vehicle 102 when performing the maneuver. This may include, for example, weather conditions, time of day, day of week, light level, etc. Such data may be useful, as such conditions may affect the ease of performing driving maneuver. For example, some maneuvers may be difficult to perform during high volume times such as rush hour but may be easier to perform otherwise. Or, some maneuvers may be difficult to perform in wintery conditions, but may be easier to perform in dry clear weather.

A raw difficulty score computation 218 may be performed using the elements extracted by the data extractor 204 from the traffic information 120. For instance, the raw difficulty score computation 218 may generate a separate raw difficulty score 220 for each maneuver indicated in the traffic information 120. These raw difficulty scores 220 may be provided to a difficulty score aggregator 222, which may utilize various raw difficulty scores 220 to determine the lane-level difficulty 132 for each lane of the roadway 122. For instance, for each lane

The raw difficulty score computation 218 may generate the raw difficulty scores 220 using various approaches. In a simple example, the raw difficulty scores 220 may be determined as a weighed average of the data elements for each value of the travel path data 214. For instance, each of the speed data 206, traffic volume data 208, speed change data 210, and wait time data 212 elements extracted by the data extractor 204 may be individually weighted as follows to create the raw difficulty scores 220:

$${rawdifficultyscore}_{lane} = \frac{\begin{matrix}( {speed}_{lane} * α + trafficvolume * β + \\ {speedchange}_{lane} * γ + {waittime}_{lane} * δ )\end{matrix}}{100}$$

### Where:

lane is one of the lanes indicated by the travel path data 214;
speedₗₐₙₑ is the speed data 206 value for the lane on a scale from 1-100;
α is a weighting of the speed data 206 in the raw difficulty score 220;
trafficvolume is the traffic volume data 208 during the time of the maneuver of the vehicle 102;
β is a weighting of the traffic volume data 208 in the raw difficulty score 220;
speedchangeₗₐₙₑ is the speed change data 210 value for the lane on a scale from 1-100;
γ is a weighting of the speed change data 210 in the raw difficulty score 220;
waittimeₗₐₙₑ is the wait time data 212 value for the lane on a scale from 1-100;
δ is a weighting of the wait time data 212 in the raw difficulty score 220; and
rawdifficultyscoreₗₐₙₑ is the raw difficulty scores 220 for the lane.

In some examples, the raw difficulty score computation 218 may weight the raw difficulty score 220 by ambient factor data 216. For example, if the weather conditions are slippery, then the raw difficulty score 220 may be adjusted upwards by a weather factor (e.g., multiplied by 1.2) to indicate the relatively more difficult traversal. Or, if it is dark out, then the raw difficulty score 220 may be weighted by a darkness factor (e.g., multiplied by 1.1) to indicate the relatively more difficult traversal.

Or, in another example, the raw difficulty score computation 218 may scale the raw difficulty scores 220 to remove the effects of the ambient factor data 216. For instance, if conditions are slippery, then more time than baseline may be required to perform the maneuver. To adjust this score to what the raw difficulty scores 220 would have been in dry conditions, then the raw difficulty score 220 may be adjusted downwards by a weather factor (e.g., divided by 1.2) to offset the effects. This approach may allow for the raw difficulty scores 220 to be created independent of the ambient factor data 216.

In yet a further example, the raw difficulty score computation 218 may be implemented as a machine learning model. For instance, a training set may be constructed of the data elements for each value of the travel path data 214 along with ground truth defined lane-level difficulty 132 scores labeled by a training expert. This data may be used to train the model to predict lane-level difficulty 132 scores in an inference mode once trained.

Regardless of approach, the difficulty score aggregator 222 may receive the raw difficulty scores 220 from the raw difficulty score computation 218 and may compile them into a single lane-level difficulty 132 for each lane of travel. For instance, the difficulty score aggregator 222 may compute an average of the raw difficulty scores 220 for each lane, resulting in the lane-level difficulty 132 for each lane. In some examples, only the highest of the raw difficulty scores 220 (e.g., the top 50%) may be average in the lane-level difficulty 132 scores, as the worst case data may be more relevant than the instances where no difficulty was shown. In some examples, outliers in the raw difficulty score 220 may also be removed, to reduce noise in the lane-level difficulty 132 scores.

While an exemplary modularization of components of the difficulty score computation 202 is described herein, it should be noted that functionality of the difficulty score computation 202 may be incorporated into more, fewer or different arranged components. For instance, while many of the components are described separately, aspects of these components may be implemented separately or in combination by one or more controllers in hardware and/or a combination of software and hardware.

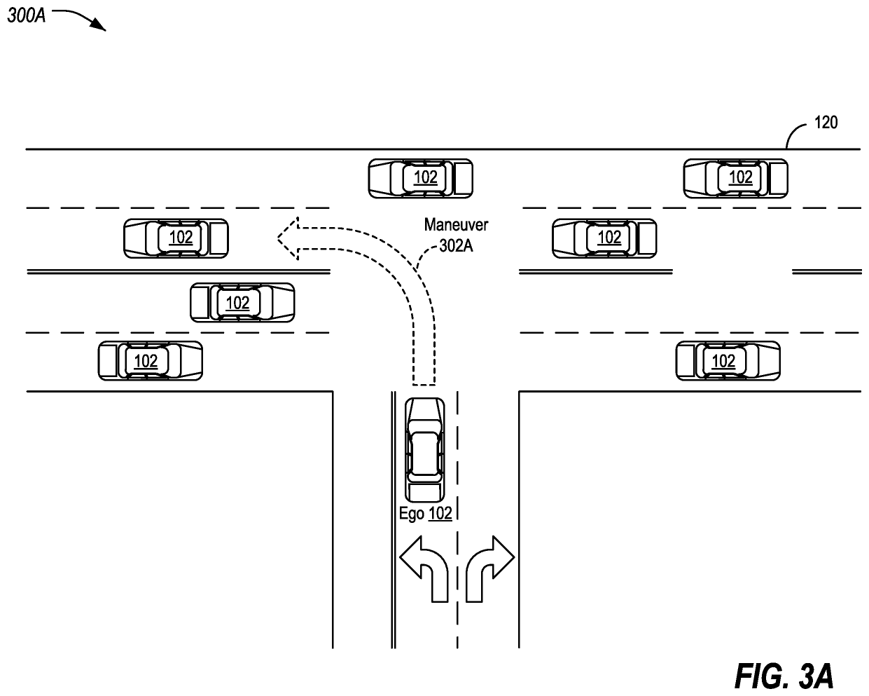

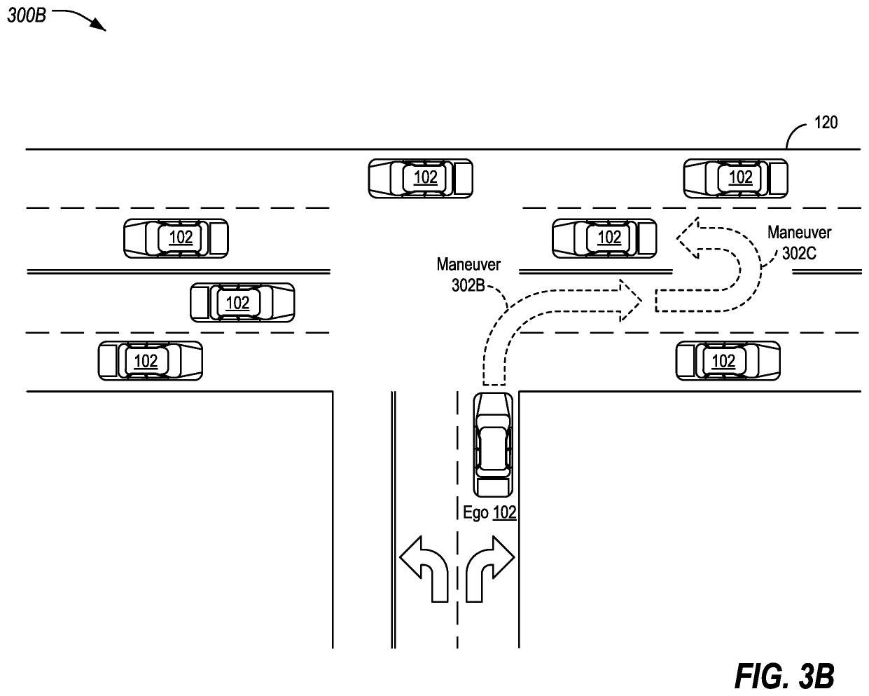

FIG. 3A illustrates an example scenario 300A of an ego vehicle 102 being routed to turn left onto a roadway 122 as a portion of a route 140. As shown, the vehicle 102 is routed to perform the turn as a single maneuver 320A. The single maneuver 320A as shown is a left turn. For sake of example, let the lane-level difficulty 132 for the left turn maneuver 320A be computed as being 70/100.

FIG. 3B illustrates an alternate example scenario 300B of the ego vehicle 102 being routed to turn left as a portion of the route 140. As shown, the vehicle 102 is routed to perform the turn as two maneuvers 320B and 320C. The first of the two maneuvers 320B as shown is a right turn onto the roadway 122. Then, the second of two maneuvers 320C is a U-turn to reverse the direction of the vehicle 102. Also, for sake of example, let the lane-level difficulty 132 for the right turn maneuver 320B be computed as being 20/100, and let the lane-level difficulty 132 for the U-turn maneuver 320C be computed as being 35/100. Other alternate route 140 examples may include computing a completely different route 140 without including the left turn intersection. The route 140 may be calculated before the ego vehicle 102 approaching the intersection. These alternate routes 140 may be slower or longer, but easier for some drivers to drive.

In the system 100A, cloud server 126 may receive a query 138 for a route 140. The query 138 may indicate the origin and destination positions of the vehicle 102 for the route 140. The query 138 may also include the difficulty preference 142 of the user (or this may be looked up by the cloud server 126 via the data store 134 or another approach). Using the difficulty preference 142 and the lane-level difficulty 132 information, the cloud server 126 may determine a route 140 where the user's preference is accounted for. In the system 100B, the routing may be performed local to the vehicle 102, using the navigation application 128 (for example).

There are various routing algorithms that can be used to determine the optimal route 140, while accounting for lane-level difficulty 132. For example, the lane-level difficulty 132 may be used to filter out lanes of travel or maneuvers that exceeds the user's difficulty preference 142. In some examples, the difficulty preference 142 may be applied as a weight along the lanes of the road segments (e.g., in addition to time or distance or other values applies to the road segments), to allow the routing to prefer lower lane-level difficulty 132. Some of the commonly used routing algorithms may include A*, Dijkstra's algorithm, Bellman-Ford algorithm, Bidirectional search, and/or Contraction Hierarchies.

Referring to FIGS. 3A-3B, assuming a user has a difficulty preference 142 of at least 70/100, that user may be routed using the single maneuver 320A (as that route 140 is shorter and more direct). However, for a user with a lower difficulty preference 142 than 70/100 (such as 50), that user may instead be routed via the two maneuvers 320B, 320C.

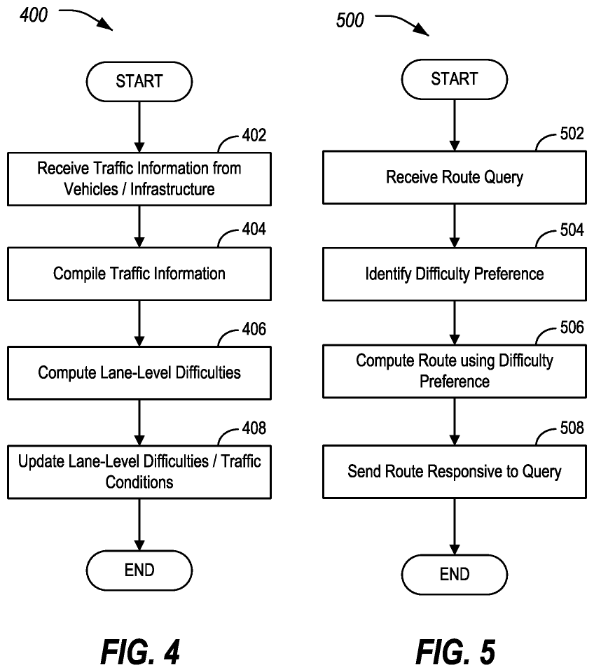

FIG. 4 illustrates an example process 400 for determining lane-level difficulties 132 along the roadway 122. In an example, the process 400 may be performed by the edge server 124 in the context of the systems 100A or 100B.

At operation 402, the edge server 124 receives traffic information 120. In an example, the traffic information 120 may be received from vehicles 102 traversing the roadway 122. In another example, at least a portion of the traffic information 120 may be received from roadside cameras 130.

At operation 404, the edge server 124 compiles current traffic information 120. For example, the edge server 124 may index the traffic information 120 by direction of travel and/or by lane for use in determining busyness of the roadway 122.

At operation 406, the edge server 124 computes the lane-level difficulty 132 information for the roadway 122. In an example, the lane-level difficulty 132 may be computed from the traffic information 120 as discussed above with respect to FIG. 2.

At operation 408, the edge server 124 updates the lane-level difficulties 132 and traffic information 120. In an example such as the system 100A, the edge server 124 may provide the lane-level difficulty 132 and the traffic information 120 to the cloud server 126 for use in handling queries 138 to generate routes 140. In an example such as the system 100B, the edge server 124 may provide the lane-level difficulty 132 and/or the traffic information 120 back to the vehicle 102. After operation 408, the process 400 ends.

FIG. 5 illustrates an example process 500 for customized routing of vehicles 102 based on the lane-level difficulty 132. In an example, the process 500 may be performed by the cloud server 126 in the context of the system 100A.

At operation 502, the cloud server 126 receives a route query 138. In an example, the vehicle 102 may send the query 138 to the cloud server 126 to request a route 140 from a current location of the vehicle 102 to a destination location.

At operation 504, the cloud server 126 identifies the difficulty preference 142 for the query 138. In an example, the query 138 may include a difficulty preference 142 of the user of the vehicle 102, which may be identified by the cloud server 126 from the query 138 itself. Or the query 138 may include an identifier of the user, which the cloud server 126 may use to look up the difficulty preference 142.

At operation 506, the cloud server 126 computes the route 140 using the difficulty preference 142. For example, as discussed above, the lane-level difficulties 132 may be filtered by the cloud server 126 to include only those maneuvers 320 that have lane-level difficulty 132 scores at or below the user's difficulty preference 142. The route 140 may also be optimized based on other factors, such as shorted time, shortest distance, steering clear areas of congestion (e.g., as identified based on the traffic information 120, etc.

At operation 508, the cloud server 126 sends the route 140 to the vehicle 102, responsive to the query 138. Accordingly, the vehicle 102 may receive and follow the route 140. After operation 508, the process 500 ends.

Variations on the process 500 are possible. In another example, the navigation application 128 of the vehicle 102 may perform aspects of the process 500 (such as operation 506) locally, without using the cloud server 126.

In some variations, the systems 100A, 100B may solicit input from the user regarding perceived difficulty. This may provide an additional approach to enabling drivers to only have to execute maneuvers that they're comfortable doing. In an example, user may be prompted by the vehicle 102 or by another device to specify a perceived difficulty of a maneuver 320 that was performed. The systems 100A, 100B may also identify a hesitancy for a user relative to average users. One, the other, or both of these factors may be compiled into a composite user profile. Individual factors in the traffic information 120 may then be weighed based on that profile. For instance, if the user displays hesitancy with performing u-turns, the difficulty of such a maneuver 320 may be increased for that user, changing the overall calculus.

Thus, an enhanced approach to route 140 generation may compute the route 140 based on maneuver 320 difficulty and user preference. Lane-level difficulty 132 scores indicative of how difficult it is to traverse that lane may be determined from traffic information 120 indicative of performance of maneuvers 320 by vehicles 102. For instance, faster speed, more changed in speed, and longer wait time may indicate a more difficult traversal. The lane of travel may be based on a direction of a turn performed by the vehicle 102 performing the maneuver 320 (e.g., if the vehicle 102 turned left, then the vehicle 102 may be assumed to have used the left turn lane). The lane-level difficulty 132 scores may be compared to a difficulty preference 142 for the vehicle 102 to ensure that the route 140 only includes maneuvers 320 that have lane-level difficulty 132 scores at or below the difficulty preference 142.

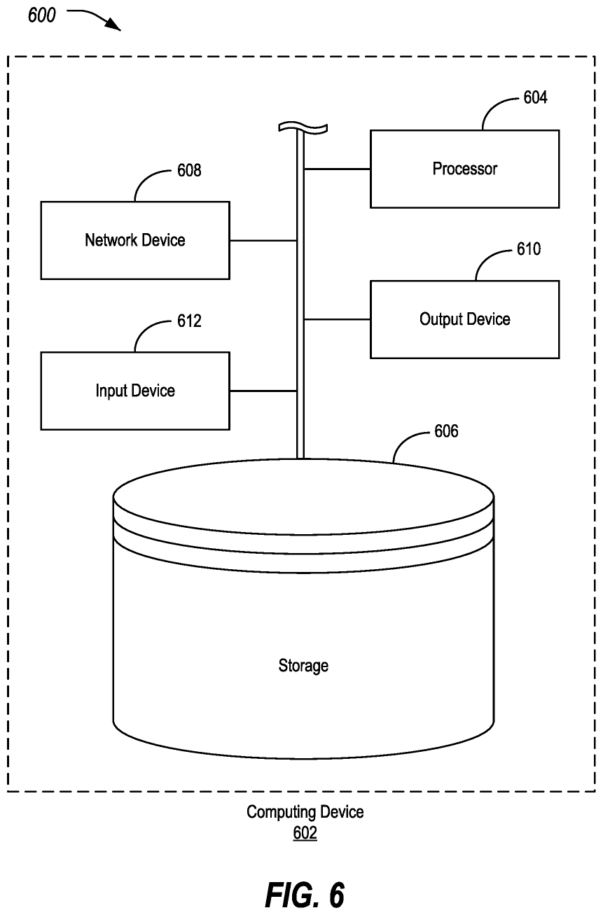

FIG. 6 illustrates an example 600 of a computing device 602 for use in interoperability of vehicles 102 having different communications technologies. Referring to FIG. 6, and with reference to FIGS. 1A-5, the controllers 104, sensors 106, TCU 110, modem 112, communication network 114, processors 116, storage 118, edge server 124, cloud server 126, roadside cameras 130, etc., may be examples of such computing devices 602. As shown, the computing device 602 may include a processor 604 that is operatively connected to a storage 606, a network device 608, an output device 610, and an input device 612. It should be noted that this is merely an example, and computing devices 602 with more, fewer, or different components may be used.

The processor 604 may include one or more integrated circuits that implement the functionality of a central processing unit (CPU) and/or graphics processing unit (GPU). In some examples, the processors 604 are a system on a chip (SoC) that integrates the functionality of the CPU and GPU. The SoC may optionally include other components such as, for example, the storage 606 and the network device 608 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stages (MIPS) instruction set families.

Regardless of the specifics, during operation the processor 604 executes stored program instructions that are retrieved from the storage 606. The stored program instructions, such as those of the navigation application 128 and navigation service 136, include software that controls the operation of the processors 604 to perform the operations described herein. The storage 606 may include both non-volatile memory and volatile memory devices. The non-volatile memory includes solid-state memories, such as not AND (NAND) flash memory, magnetic and optical storage media, or any other suitable data storage device that retains data when the system is deactivated or loses electrical power. The volatile memory includes static and dynamic random-access memory (RAM) that stores program instructions and data during operation of the systems 100A and 100B. This data may include, as non-limiting examples, the traffic information 120, lane-level difficulty 132, route 140, difficulty preference 142, speed data 206, traffic volume data 208, speed change data 210, wait time data 212, travel path data 214, ambient factor data 216, and raw difficulty scores 220.

The GPU may include hardware and software for display of at least two-dimensional (2D) and optionally three-dimensional (3D) graphics to the output device 610. The output device 610 may include a graphical or visual display device, such as an electronic display screen, projector, printer, or any other suitable device that reproduces a graphical display. As another example, the output device 610 may include an audio device, such as a loudspeaker or headphone. As yet a further example, the output device 610 may include a tactile device, such as a mechanically raiseable device that may, in an example, be configured to display braille or another physical output that may be touched to provide information to a user.

The input device 612 may include any of various devices that enable the computing device 602 to receive control input from users. Examples of suitable input devices that receive human interface inputs may include keyboards, mice, trackballs, touchscreens, voice input devices, graphics tablets, and the like.

The network devices 608 may each include any of various devices that enable the devices discussed herein to send and/or receive data from external devices over networks. Examples of suitable network devices 608 include an Ethernet interface, a Wi-Fi transceiver, a Li-Fi transceiver, a cellular transceiver, or a BLUETOOTH or BLUETOOTH low energy (BLE) transceiver, or other network adapter or peripheral interconnection device that receives data from another computer or external data storage device, which can be useful for receiving large sets of data in an efficient manner.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for customized routing of vehicles based on lane-level difficulty, comprising:
a data store configured to maintain lane-level difficulty scores for a plurality of lanes of travel of roadway, the lane-level difficulty scores being computed based on traffic information compiled from a plurality of vehicles having traversed the roadway; and
one or more processors, configured to:
receive a query for a route from a vehicle,
identify a difficulty preference for the vehicle based on the query,
compute the route to include only maneuvers that have lane-level difficulty scores at or below the difficulty preference, and
send the route to the vehicle, responsive to the query.

2. The system of claim 1, wherein the one or more processors are further configured to:
extract data elements from the traffic information indicative of performance of maneuvers by the vehicles;
determine raw difficulty scores for each of the maneuvers based on the data elements;
identify lanes of travel for the maneuvers; and
for each lane, generate the lane-level difficulty score based on the raw difficulty scores corresponding to the maneuvers using that lane.

3. The system of claim 2, wherein the data elements include:
speed data indicative of how fast the vehicles performed the maneuvers;
speed change data indicative of how often the vehicles changed speed during the maneuvers; and/or
wait time data indicative of how long the vehicles took to perform the maneuvers.

4. The system of claim 2, wherein to identify the lanes of travel for the maneuvers includes to infer the lane of travel through an intersection based on a direction of a turn performed by the vehicle.

5. The system of claim 2, wherein the one or more processors are further configured to:
compute an average of the raw difficulty scores for each lane, resulting in the lane-level difficulty for each lane.

6. The system of claim 5, wherein the average is a weighted average using weights for each of the data elements.

7. The system of claim 5, wherein a highest subset of raw difficulty scores are utilized in computing the average.

8. The system of claim 2, wherein the one or more processors are further configured to:
scale the raw difficulty scores to remove effects of ambient factors in determining the lane-level difficulty scores;
determine the lane-level difficulty scores using the raw difficulty scores as scaled; and
compute the route using the lane-level difficulty scores scaled to current ambient factors.

9. A method for customized routing of vehicles based on lane-level difficulty, comprising:
extracting data elements from traffic information indicative of performance of maneuvers by the vehicles;
determining raw difficulty scores for each of the maneuvers based on the data elements;
identifying lanes of travel for the maneuvers;
for each lane, generating a lane-level difficulty score based on the raw difficulty scores corresponding to the maneuvers using that lane; and
routing vehicles accounting for the lane-level difficulty scores to include only maneuvers that have lane-level difficulty scores at or below a difficulty preference.

10. The method of claim 9, further comprising:
receiving a query for a route from a vehicle;
identifying the difficulty preference for the vehicle based on the query;
computing the route to include only maneuvers that have lane-level difficulty scores at or below the difficulty preference; and
sending the route to the vehicle, responsive to the query.

11. The method of claim 9, wherein the data elements include:
speed data indicative of how fast the vehicles performed the maneuvers;
speed change data indicative of how often the vehicles changed speed during the maneuvers; and/or
wait time data indicative of how long the vehicles took to perform the maneuvers.

12. The method of claim 9, wherein to identify the lanes of travel for the maneuvers includes to infer the lane of travel through an intersection based on a direction of a turn performed by the vehicle.

13. The method of claim 9, further comprising:
computing an average of the raw difficulty scores for each lane, resulting in the lane-level difficulty for each lane.

14. The method of claim 13, wherein the average is a weighted average using weights for each of the data elements.

15. The method of claim 13, wherein a highest subset of raw difficulty scores are utilized in computing the average.

16. The method of claim 9, further comprising:
scaling the raw difficulty scores to remove effects of ambient factors in determining the lane-level difficulty scores;
determining the lane-level difficulty scores using the raw difficulty scores as scaled; and
performing the routing using the lane-level difficulty scores scaled to current ambient factors.

17. A non-transitory computer-readable medium comprising instructions for customized routing of vehicles based on lane-level difficulty that, when executed by one or more processors, cause the one or more processors to perform operations including to:
extract data elements from traffic information indicative of performance of maneuvers by the vehicles;
determine raw difficulty scores for each of the maneuvers based on the data elements;
identify lanes of travel for the maneuvers;
for each lane, generate a lane-level difficulty score based on the raw difficulty scores corresponding to the maneuvers using that lane;
receive a query for a route from a vehicle;
identify a difficulty preference for the vehicle based on the query;
compute the route to include only maneuvers that have lane-level difficulty scores at or below the difficulty preference; and
send the route to the vehicle, responsive to the query.

18. The medium of claim 17, wherein the data elements include:
speed data indicative of how fast the vehicles performed the maneuvers;
speed change data indicative of how often the vehicles changed speed during the maneuvers; and/or
wait time data indicative of how long the vehicles took to perform the maneuvers.

19. The medium of claim 18, wherein to identify the lanes of travel for the maneuvers includes to infer the lane of travel through an intersection based on a direction of a turn performed by the vehicle.

20. The medium of claim 19, further comprising computing a weighted average of the raw difficulty scores for each lane, resulting in the lane-level difficulty for each lane.
